(19) United States
(12) Patent Application Publication
(10) Pub. No.: US 2024/0057820 A1
(43) Pub. Date: Feb. 22, 2024

(54) INTELLIGENT KITCHEN MACHINE FOR THE RAPID PREPARATION OF TAILORED FOOD ORDERS

(71) Applicant: Igor Sergeevich LERNER, Yaroslavl (RU)

(72) Inventor: Igor Sergeevich LERNER, Yaroslavl (RU)

(21) Appl. No.: 18/269,857

(22) PCT Filed: Dec. 3, 2021
(86) PCT No.: PCT/RU2021/000539

§ 371 Date: Jun. 27, 2023

(30) Foreign Application Priority Data
Dec. 28, 2020 (RU) 2020143383

(51) Int. Cl. A47J 44/00

(52) U.S. Cl. CPC A47J 44/00

(57) ABSTRACT

The proposed kitchen equipment relates to the field of professional kitchen systems. A kitchen complex comprises a food distribution system and a conveyor system for cooperation therewith. The food distribution system is configured in the form of a set of robotized metering modules for topping a given number of incoming pre-prepared food bases with portions of edible ingredients. The conveyor system is comprised of at least two robotized functionally synchronized two-coordinate carrier tables mounted on supporting conveyance equipment, at the end sections of which are peripheral platforms for temporarily receiving the two-coordinate carrier tables. Said tables are capable of moving along a pre-determined route controlled by a control device according to pre-established parameters of a requested food item that are completely or partially moved by transfer equipment from an independently movable working platform of one two-coordinate carrier table to an independently movable working platform of the other two-coordinate carrier table.

### FIELD OF THE INVENTION

The proposed intelligent kitchen equipment relates to the field of professional kitchen systems having modern technical equipment that allows one to successfully compete in the field of robotics designed for use in a culinary environment to prepare various food dishes, including restaurant dishes, author's dishes, i.e., those prepared according to a pre-made recipe, as well as the most popular and high-demand fast food products which include pizza, pancakes and sandwiches.

### BACKGROUND OF THE INVENTION

CN 111317380 A (IPC A47J 44/00, published in 2020; hereinafter—[1]) discloses a system for storing and supplying prepared food products.

The system disclosed in [1] is directly related to the field of automated kitchen equipment used in the professional field to provide the automation of services in the operation of public catering systems in public places.

The analyzed culinary unit disclosed in [1] comprises a few basic equipment required to implement the assigned functionality, which include a food distribution system, as well as an associated system for storing and supplying compiled and prepared food orders.

The pieces of equipment interacting with each other is controlled by a central computer system which generates necessary commands and monitors the operations performed, including supervises the operation of a conveyor system.

In turn, the conveyor system is configured as a robotic manipulator having a gripping device for holding and placing food orders.

The unit known from [1] essentially combines the functionality of cooking with the subsequent functionalities of temporarily storing and alternately distributing the food orders as they are identified, which becomes possible and manifests itself as a result of the delivery of ready-made food sets to a user access area and their capture according to consumer needs.

The food unit disclosed in [1] may not be successfully used as an independent system, because its constructive and technical aspects are focused on interaction with a group of combined pieces of food equipment, which in terms of technology can have a positive effect on industrial production potential, but at the same time, this feature can lead to difficulties associated with the complexity of integration and interaction between the involved subsystems, accompanied by conflict software architectures from different vendors.

Additional disadvantages are a non-standard design, as well as a specialized purpose and the need to manufacture replacement parts to order, which greatly complicates the creation of an established and unified production process and does not actually create favorable conditions for bulk production of equipment of this type.

KR 20190106893 (IPC A23P 30/10, published on Sep. 18, 2019; hereinafter—[2]) discloses a culinary robotic system.

The system known from [2] has a highly specialized profile and is configured to process incoming food products and convert them into a relatively solid and compact form suitable for transportation, including over long distances.

The fundamental components of the system known from [2] include a food distribution system and a food conveyor system that interacts with the food distribution system.

Significant peculiarities of the system that determine its purpose and operation features are the implementation of the distribution system in the form of an adaptive robotic manipulator that is an analogue of human hands, creating an imitation of manual labor through the operation of artificial intelligence systems, which generally allows solving assigned culinary tasks by effectively interacting with a system for transporting food raw materials that is made as a set of interconnected integrated pieces of equipment located at different levels, including screw-conveyor systems, conveyors, distributors, dosing devices and tunnel pneumatic conveyors.

The significant drawback of the system under study [2] should be considered the lack of guarantees for the success of commercial use and successful introduction of such systems into industrial circulation, since the area of permissible application is very experimental and is limited by the possibility of processing products into a convenient option for transfer, which may cause demand from logistics companies—however from an economic point of view, stable demand and profitability for such services are hardly possible.

Additional disadvantages are as follows: the extreme complexity of the practical creation and successful use of a robotic simulator of human hands that is configured to fully replace the manual labor of a biological organism, and as a result, the inability to ensure the high accuracy of repetitions, manipulations and sensitivity of movements peculiar to a person. This is caused by the fact that human hands have an essentially unlimited potential, have many receptors, as well as the ability to perform an unlimited number of movements, combinations and various manipulations, and the current level of technical progress (development) is not able to influence the creation of an artificial analogue that can fully reproduce the capabilities of a person, in particular, to fully replace the abilities of human hands, including the successful perception of learning and the adoption of independent decisions that are inconsistent with the installed software.

CN 109725559 (IPC G05B 19/042, published in 2019; hereinafter—[3]) discloses an automated kitchen system that is closest in technical essence to the claimed invention.

The system known from [3] technically involves the automation of the processes of food preparation, transportation and storage, as well as their rational combination in one system.

The system disclosed in [3] is controlled by a computer and comprises a food distribution system and a conveyor system that interacts with the food distribution system. The distribution system comprises means for distributing food contents, and the conveyor system comprises a two-coordinate desktop.

According to the author's design, the food distribution system is divided into a food preparation subsystem, as well as into first and second transmission systems, while the conveyor system is divided into two subsystems combined in a single structural unit. In addition, there is a storage system for temporarily storing resulting food products and maintaining their marketable state.

The technical solution of [3] includes the main operations associated with the production of ready-to-eat food dishes.

In a practical sense, the food system of [3] can be adapted mainly for use in factory conditions, since it needs to interact with loading equipment, and also has an industrial design and potential comparable to the volumes of products produced by industrial enterprises, which cumulatively determines the dependent position of the system and indicates the undesirability and inefficiency of its use in autonomous public catering facilities or in the form of an individual food unit capable of autonomous operation.

The system known from [3] also has a complex design, as well as a large number of non-standard and narrow-profile parts and subsystems, the configuration and operation of which will require constant monitoring and desirable maintenance technical work. This will necessarily require the involvement of large resources to create and maintain this level and scale of technological installations, the justification for the collection of which in the conditions of constant market competition cannot be guaranteed.

### SUMMARY OF THE INVENTION

The technical problem to be solved by the invention is the creation of an intelligent kitchen machine that is configured to create food dishes according to individual author's recipes, while ensuring market competitiveness and high performance.

The technical result of the invention, which solves the above technical problem, is the implementation of the purpose of creating a computer-controlled robotic culinary machine configured to create a wide range of food dishes prepared based on author's recipe data in a high-speed mode while maintaining proper quality.

The technical result is achieved and the technical problem is solved by the fact that an intelligent kitchen system for the urgent preparation of individual customer orders comprises a food distribution system and a conveyor system that interacts with the food distribution system. The food distribution system is configured as a set of robotic metering modules for topping a given number of incoming pre-prepared food bases with portions of edible ingredients according to a certain work cycle. The conveyor system comprises at least two robotic functionally synchronized two-coordinate carrier tables mounted on an equipped supporting track facility, at the end sections of which there are peripheral platforms for temporarily receiving the two-coordinate carrier tables during a working process. The two-coordinate carrier tables are configured to move, including jointly move, along a pre-determined, tailored topping route controlled by an intelligent control device according to pre-received, pre-established parameters of an ordered food dish that is able to be completely or partially moved by product transferring means from an independently movable working platform of one two-coordinate carrier table to an independently movable working platform of another two-coordinate carrier table.

According to one of the most preferred embodiments of the invention, the equipped supporting track facility is configured as two statically mounted guides.

It is advisable if the statically mounted guides are structurally adapted to interact with roller mechanisms.

According to one of the most promising embodiments of the invention, the independently movable working platform of the two-coordinate carrier tables is installed on a base and has a lower part that moves in a longitudinal direction and an upper part that moves in a transverse direction.

According to particular embodiments of the invention, the two-coordinate carrier tables may be equipped with product quality monitoring tools which may be represented by photo and/or video cameras.

According to promising embodiments of the invention, the intelligent control device may analyze incoming images from the product quality monitoring tools and subsequently generate, in case of incomplete reference compliance of products, programmed command signals activating necessary operational modes of the equipment which are aimed at eliminating deficiencies of the products.

The food bases used in the invention may be made from dough, are preferably flat and generally have a round and/or oval and/or rectangular and/or square configuration.

It is most rational if the robotic metering modules of the food distribution system are installed sequentially in a row and comprise loose, pasty, solid, semi-solid, and also liquid food additives and ingredients.

At the same time, these food additives and ingredients may comprise meat and/or sausage products and/or ham and/or fish and/or cheese and/or vegetables and/or fruits and/or berries and/or herbs and/or sauce and/or spices and/or oil and/or syrup and/or cereals and/or dough.

It is the most reasonable and rational if the product transferring means that is used in the invention will be provided on the working platforms of the two-coordinate carrier tables and will be implemented as automatic electric drive systems comprising horizontally moving feeders which are activated if the two-coordinate tables come into contact with each other.

It is possible to implement the invention, when the working platform of the two-coordinate carrier tables is additionally configured to rotate around an axis.

According to one of the possible embodiments of the invention, the two-coordinate carrier tables may comprise reference scales for accurately measuring the weight of products.

According to one of the particular embodiments of the invention, the peripheral platforms used may be equipped with means for removing low-quality food bases.

According to the developed inventive concept, attention is drawn to a modern and competitive system for producing ready-to-eat food dishes prepared according to various and pseudo-random author's recipes compiled directly in the process of making a food order.

Technological innovation, according to the author, is a promising technology that uses programmable equipment operating in automatic mode and combines a robotic distribution system and a robotic conveyor system. It is important to note that the operation of the existing equipment is controlled by an intelligent device (computer system) having modern software that controls the course of work, as well as allows one to make user settings in advance and successfully program the system to operate according to an individual plan necessary to obtain a certain food dish having its inherent individual characteristics in accordance with the author's preferences of an individual user.

The basic features of the proposed kitchen system for the urgent preparation of individual customer orders, which make a significant contribution to the existing state of the art, is the combination of the well-functioning operation of the food distribution system and the conveyor system. Additionally, in accordance with the inventive concept, the food distribution system is configured as the set of robotic metering modules, and the transport system is implemented as a subsystem comprising at least two two-coordinate carrier tables, the coordinated spatial movement of which is determined and coordinated by the intelligent control device.

Particular attention, from the point of view of the inventive concept, should be paid to the mentioned subsystem of the two-coordinate carrier tables installed on the equipped supporting track facility which is provided with the peripheral platforms for temporary receiving, during the direct working process, the two-coordinate carrier tables themselves, the movement of which, including joint (connected) movement, becomes possible based on a pre-agreed tailored topping route, the operation of which is controlled by the intelligent control device.

In functional terms, the used two-coordinate carrier tables are configured, due to the product transferring means, to transfer dishes or individual components of a food dish from the working platform of one carrier table to the working platform of another carrier table.

In technical terms, by using the combined system which comprises the two interconnected main subsystems responsible for distributing food ingredients, positioning food bases, as well as for moving the bases along a defined unique production path with access to the temporary receiving (staying) area in the proposed intelligent kitchen system controlled by the intelligent device, one can obtain the intelligent kitchen machine capable of creating dishes according to the author's vision, while working mainly according to a corrective work cycle, the operational features of which include: the controlled and metered distribution of the food ingredients on the food bases, the development of the topping route, including the possible location of the bases in the peripheral points of temporary (short-term) stay and the possible controlled movement of dishes or their individual components from one two-coordinate carrier table to another two-coordinate carrier table. All of this helps to increase the speed of formation of a final dish and the correct organization of the movement of all equipment, as well as maintain defined recipe requirements for obtaining high-quality products. Thanks to the high positional accuracy of applying the ingredients and the controlled automation of the correct organization of their application, a qualitative balance of food raw materials is ensured, which in turn forms the basis of a product and determines its final appearance.

In engineering terms, the transfer of the food ingredients from one two-coordinate carrier table to another is due to the fact that there is no need for one carrier table to transfer the same food base to the final route, since this may be done by the second carrier table, and at the time of transfer, the first table may already receive a command from the intelligent device to take another food base to form a next ordered food dish. In addition, under the conditions of predominant reverse movement, the intellectual operation of the tables may be additionally controlled using the peripheral platforms, where the table waits (defends) for the moment when another table, for technical reasons, needs go along the entire length of the equipped supporting track facility, which in turn significantly and comprehensively increases labor productivity, providing an increase in the speed of work, while maintaining the production quality at a proper high level peculiar to technological robotic equipment.

Thus, given its characteristics and technical features, the above-proposed constructive implementation of the intelligent culinary system for the urgent preparation of individual customer orders forms a set of features sufficient to achieve the desired technical result, which consists in realizing the purpose of creating a computer-controlled robotic kitchen machine configured to create a wide range of food dishes prepared based on author's recipe data in a high-speed mode with proper quality, as well as to solve the actual technical problem of obtaining the intelligent machine for professional kitchens that embodies the possibilities of creating author's accent food dishes, while providing market advantages and high technical characteristics.

### BRIEF DESCRIPTION OF THE DRAWINGS

FIG. 1 shows a general diagram of a proposed intellectual culinary system;

FIG. 2 shows a block diagram of a top view of the proposed intelligent culinary system;

FIGS. 3a, 3b, 3c, 3d, 3e and 3f show diagrams explaining the operation of carrier tables without transferring a food base to each other, namely: FIG. 3a shows an embodiment when an order is expected; FIG. 3b shows an embodiment when a first order is received and it is executed on one carrier table; FIG. 3c shows an embodiment when a second order is received and the first and second orders are executed simultaneously on the two tables; FIG. 3d shows an embodiment when one order is completed and the table is ready for its subsequent transfer, while another order is executed on another table; FIG. 3e shows an embodiment when one of the tables waits for a command at a peripheral waiting platform, and another table is ready for the subsequent transfer of the order; and FIG. 3f shows an embodiment when both orders are transferred and both tables are ready to execute next orders;

FIGS. 4a, 4b, 4c, 4d, 4e and 4f show diagrams explaining the operation of the carrier tables when transferring an order from one table to another, namely: FIG. 4a shows an embodiment when an order is expected; FIG. 4b shows an embodiment when a first order is received and it is executed on one of the tables; FIG. 4c shows an embodiment when a second order is received and both orders are executed simultaneously on the two tables; FIG. 4d shows an embodiment when one of the tables has executed the order and passes it to a next stage, while another table continues to execute its order; FIG. 4e shows an embodiment when the empty table drives up to another table and the latter transfers the partially executed order to the empty table; and FIG. 4f shows an embodiment when one of the tables completely executes the order that was previously on another table which at that time waits for a next order to execute;

FIGS. 5a, 5b and 5c illustrate the possibility of interaction of the two-coordinate carrier tables with each other, namely: FIG. 5a shows a pair of tables having drive systems installed thereon; FIG. 5b shows how a food base is transferred to the left from one table to another; and FIG. 5c shows how the food base is transferred to the right from one table to another;

FIG. 6 shows a side view of one of the carrier tables;

FIG. 7 is a top view of one of the carrier tables.

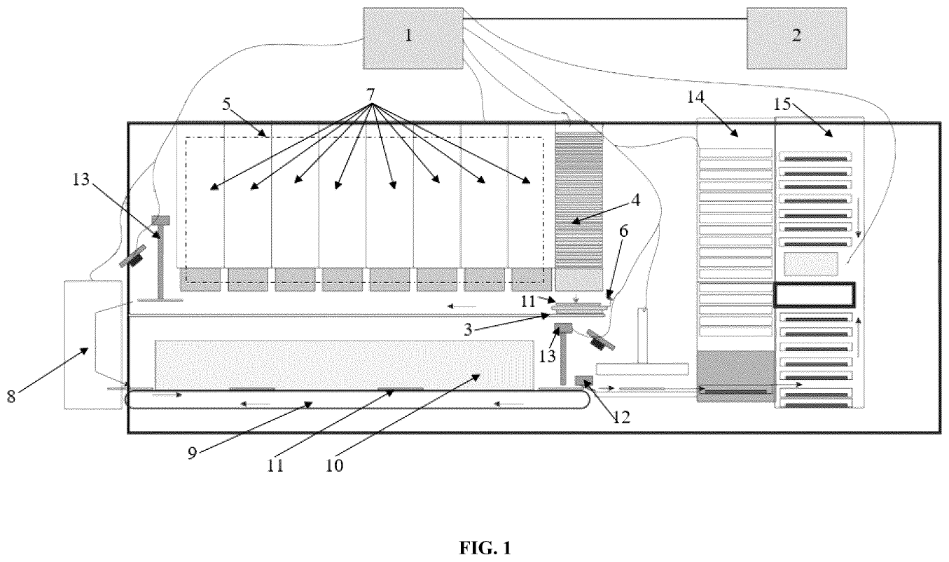

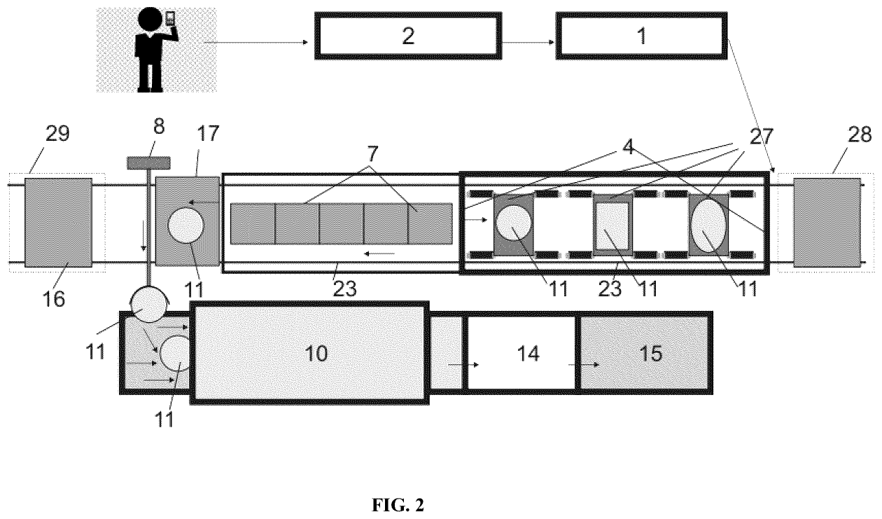

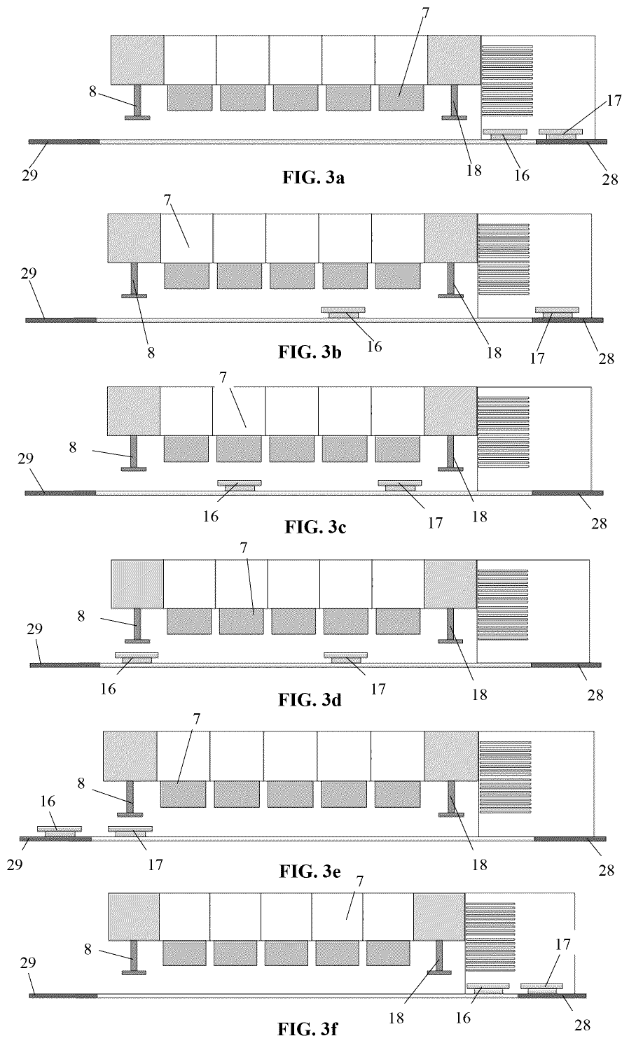

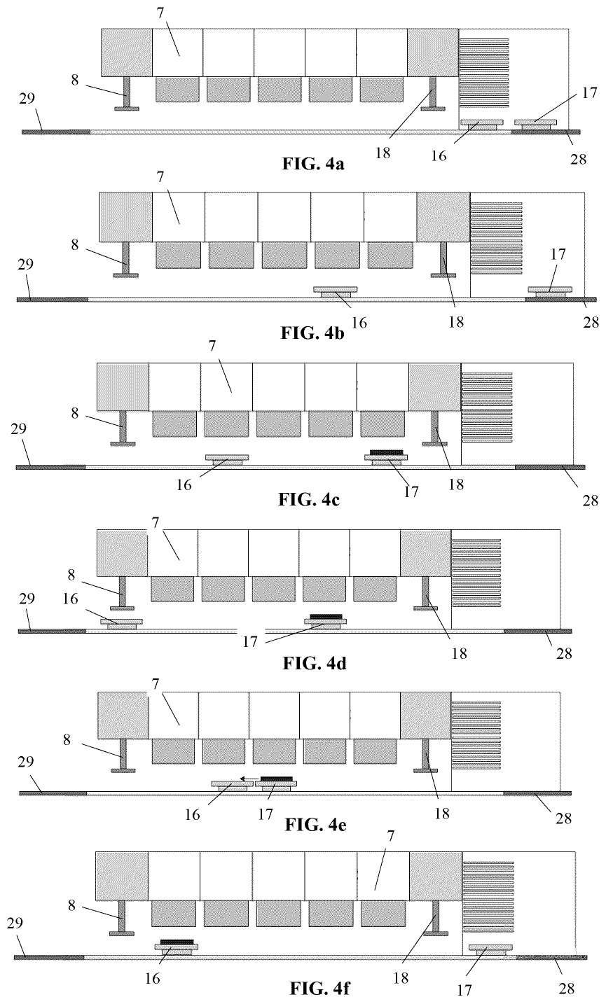

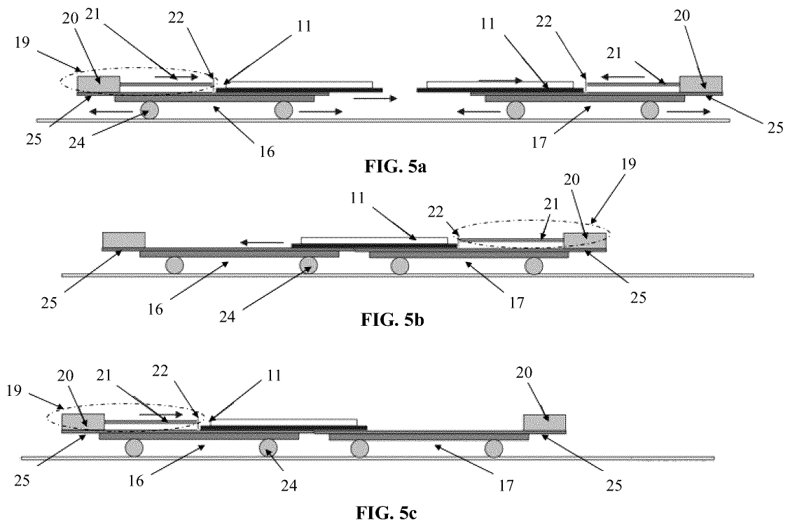

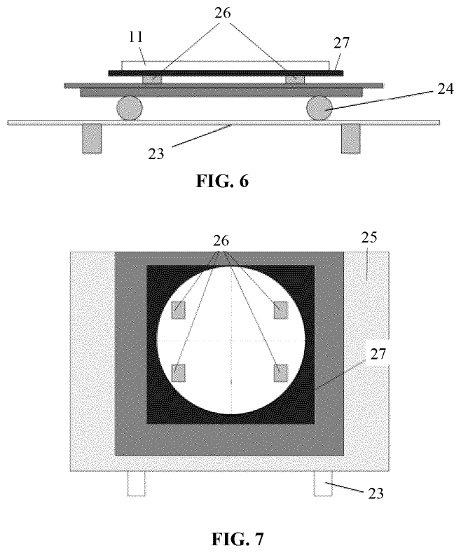

### DETAILED DESCRIPTION OF THE INVENTION

The invention is explained by a specific exemplary embodiment which, however, is not the only possible, but clearly demonstrates that the specified set of essential features allows one to achieve the desired technical result, as well as to solve the existing technical problem.

The listed figures show the following parts and elements of the proposed intellectual culinary system:
1—intelligent control device;
2—central serving server;
3—conveyor system;
4—food base temporary storage and issuance system;
5—food distribution system;
6—product quality monitoring tool;
7—set of metering modules;
8—product transferring means;
9—belt conveyor device;
10—furnace installation;
11—food base;
12—product transferring element;
13—executive elements for removing low-quality products;
14—packaging subsystem;
15—finished and packaged product storage and issuance subsystem;
16—first two-coordinate carrier table;
17—second two-coordinate carrier table;
18—means for transferring products to packaging;
19—automatic electric drive system;
20—pusher;
21—movable feeder;
22—feeder stop;
23—guides;
24—roller mechanisms;
25—independently movable working platforms;
26—reference scales;
27—metal base;
28—first temporary storage platform;
29—the temporary storage platform.

The proposed culinary system for the urgent preparation of individual customer orders comprises a food distribution system 5 and a conveyor system 3 that interacts with it.

The food distribution system 5 is configured as a set of robotic metering modules 7 which top a given number of incoming pre-prepared food bases 11 with portions of edible components and ingredients. The movement of the food bases 11 is performed according to an established work cycle.

The conveyor system 3 is configured as two robotic two-coordinate carrier tables 16 and 17, respectively, which are mounted on an equipped supporting track facility implemented as statically installed profile guides 23.

At the end sections of the profile guides 23, there are peripheral platforms 28 and 29 for short-term storage of the two-coordinate carrier tables 16 and 17, respectively. Said storage is carried out mainly during the working process.

The movement of the two-coordinate tables 16 and 17, including their joint movement, is performed along a predetermined tailored topping route controlled by an intelligent control device 1 which is connected to a central service server 2.

It is important to note that the previously agreed tailored topping route is controlled by the intelligent control device 1 in accordance with previously received and processed parameters and features of a food dish ordered by a user.

According to the invention, the food dish to be prepared may be fully or partly moved by equipped transferring means from an independently movable working platform 25 of one two-coordinate carrier table to an independently movable work platform 25 of another two-coordinate carrier table.

The equipped transferring means are made as automatic electric drive systems 19 and, as an option, are installed on the independently movable working platforms 25 and comprise a pusher 20, a movable feeder 21 and a feeder stop 22. In this case, the horizontally movable feeder 21 is activated if the two-coordinate carrier tables 16 and 17 come into contact with each other, for which reason the food base 11 moves from one table to another under the action of the feeder stop 22.

In this embodiment, the independently movable working platform 25 of the two-coordinate carrier tables 16 and 17 is mounted on a base and has a lower part that moves in a longitudinal direction and an upper part that moves in a transverse direction.

The two-coordinate carrier tables 16 and 17 are equipped with a product quality monitoring tool 6 which is configured as a digital video camera transmitting information to the intelligent control device 1. In this case, the control device 1 analyzes the information and, in case of incomplete reference compliance of products, generates programmed command signals that activate the necessary operational modes of the equipment which are aimed at eliminating deficiencies of the products.

The two-coordinate carrier tables 16 and 17 are also equipped with reference scales 26.

The proposed intellectual culinary system operates as follows.

It should be noted that the purpose of the following description of the invention is not to limit it to a specific embodiment, but rather to cover all possible additions that do not go beyond the scope of the appended claims.

A production process is controlled by the intelligent device 1 which is connected to the central service server 2 connected to the Internet.

The intelligent control device 1 and the central serving server 2 can use software, by which the transmission of information about incoming orders and the operation of the equipment of the proposed intelligent culinary system is provided.

It is possible to order a certain culinary product, for example, pizza, pancakes or sandwiches, as well as select its filling and indicate the features of its preparation, by using a software application on any electronic device or directly in the culinary system that has such an opportunity. The intelligent control device 1 receives the corresponding signal, processes it and then forms a certain operational mode of the equipment, in particular, determines the topping route of the conveyor system 3, namely: synchronizes the operation of the two-coordinate carrier tables 16 and 17, selects the optimal speed of their movement, fixes the time of their movement and stops, as well as determines other production parameters and the operational modes of the food distribution system 5, determines the dosage of components, synchronizes the operation of the metering modules 7, checks them for the presence of certain food ingredients and components, as well as determines other necessary production parameters required for preparing specific food dishes.

It is important to note that the database of the central serving server 2 stores all possible programs for preparing various culinary products, including the operational modes of the conveyor system 3 and the operational modes of the food distribution system 5.

In the proposed culinary system, as a rule, frozen dough-contained food bases 11 are used, which are mainly flat and have a round and/or oval and/or rectangular shape.

After the central serving server 2 receives information about the order of a certain product, the intelligent control device 1 generates, through a software algorithm, a command for a food base temporary storage and issuance system 4 to supply the food base 11 to the first two-coordinate carrier table 16. Said supply is mechanically carried out by means of an actuator configured as an electric drive equipped with a piston, a pusher and a gripping means.

Once on the independently movable working platform 25 of the first two-coordinate carrier table 16, the food base 11 moves towards the opposite end of the section of the track guides 23. In the process of movement, the first two-coordinate carrier table 16 passes under the required set of metering modules 7, making stops and pauses for the food base 11 to be topped with a necessary set of food components and ingredients. If necessary, the working platform 25 is moved to two opposite sides of a conveyance path, thereby selecting accurate and clear places for loading the food components and ingredients, which is possible due to the independence of the movement of the working platform 25 that can also rotate around its axis. After all the necessary ingredients from the metering modules 7 arrive at the food base 11, the first two-coordinate carrier table 16 moves to the area of action of a product transferring means 8 which moves the food base 11 to a furnace installation 10.

In the event that the first two-coordinate carrier table 16 has not yet completed its movement, and the ingredients for the food base 11 are still being collected, and the serving server 2 receives information about the need to execute a next order, the intelligent control device 1 generates, through the software algorithm, a command for the temporary storage and issuance system 4 to supply the food base 11 to the second two-coordinate carrier table 17 which begins its movement towards the opposite end of the section of the track guides 23 and towards the first two-coordinate carrier table 16.

After the first two-coordinate carrier table 16 finishes its work, and the food base 11 is moved by means of the product transferring means 8 to the furnace installation 10, the first two-coordinate carrier table 16 will move close to the second two-coordinate carrier table 17.

Further, if necessary, the food base 11 is transferred from the working platform 25 of the two-coordinate carrier table 17 to the working platform 25 of the adjacent two-coordinate carrier table 16. This is done with the help of the transferring means, namely with the help of the automatic electric drive systems 19, the horizontally movable feeders 21 of which are activated if the two-coordinate carrier tables come into contact with each other. In this case, the feeders 21 have grippers 22 and move due to the action of the pushers 20, as a result of which the partially finished food base 11 is transferred to the working platform 25 of the two-coordinate carrier table 16. Once on the working platform 25 of the two-coordinate carrier table 16, the food base 11 continues its movement along the topping route, being topped, if necessary, with the food ingredients and components according to a recipe. Then, according to an approved cooking plan, the food base 11 is transferred to the furnace installation 10 for baking, which is carried out by the product transferring means 8. Alternatively, in the absence of the baking stage in accordance with the order, the food base 11 is transferred again to the two-coordinate carrier table 17 in reverse order with the help of the already used automatic electric drive system 19, after which the resulting food base 11 is transferred to a packaging subsystem 14 by a product transferring means 18, from which a packaged product goes directly to a finished and packaged product storage and issuance subsystem 15.

It is also extremely important that in conditions of predominant reverse movement, the intellectual operation of the two-coordinate carrier tables 16 and 17 is additionally controlled using the peripheral platforms 28 and 29, where one of the tables waits (defends) for the moment when another table needs to go along the entire length of the track facility, i.e., along the entire length of the track guides 23. This, in turn, significantly and comprehensively increases the productivity of the conveyor system 3, providing an increase in the speed of work, while maintaining production quality at a proper high level peculiar to technological robotic equipment. An example is the situation when 2 orders are received at the same time, as a result of which the two-coordinate carrier tables 16 and 17 are simultaneously loaded with food bases 11 and the food bases 11 are further topped with the necessary ingredients. In such a situation, the first carrier table 16 drives up to the product transferring means 8 and stops. The product transferring means 8 transfers the food base 11 from the carrier table 16 to the working part of the furnace installation 10. After that, in order for the second carrier table 17 to be able to transfer its food base 11 through the transferring means 8 to the working part of the furnace installation 10, the first carrier table 16 moves to the peripheral platform 29, thereby freeing up space for the second carrier table 17 which can then move into the action area of the product transferring means 8.

Another example of the use of the peripheral temporary storage platforms 28 and 29 is the situation when the two-coordinate carrier table 16 executed and transferred the order using the product transferring means 8 to the furnace installation 10, the two-coordinate carrier table 17 continues to execute the order, and at the same time a next order is received. In this case, having calculated the time for completing the orders by each of the tables or taking into account the recipe for preparing each of the orders (for example, the absence of the baking stage for the food base 11 located on the two-coordinate carrier table 17), the intelligent control device 1 takes, by means of the software algorithm, the decision that it is better not to transfer the food base 11 from one two-coordinate carrier table to another, but it is more optimal to use the peripheral platform 28. For this, the two-coordinate carrier table 17 with the partially executed order is moved to the peripheral platform 28, thereby freeing up space for the first two-coordinate carrier table 16 which then will be able to move to the action area of the food base temporary storage and issuance system 4, receive the next food base 11 and proceed to fulfill the received order. After that, the two-coordinate carrier table 17 will complete its order.

After the orders are executed and transferred by means of the product transferring means 8 to the furnace installation 10 or by means of the product transferring means 18 to the packaging subsystem 14, both two-coordinate carrier tables 16 and 17 are moved to the peripheral platform 28 to wait for next orders.

It should be noted that the product transferring means 8 is made as a piston-pusher with a gripping means, which, while holding the food base 11, transfers it to a belt conveyor device 9 of the furnace installation 10. The product transferring means 18 is also made as a piston-pusher with a gripping means, which transfers the products directly to the packaging subsystem 14, bypassing the baking stage in the furnace installation 10.

The intelligent control device 1 is also pre-provided with data-coordinates of the action area of each metering module 7, as a result of which the intelligent control device 1 causes the food base 11 to be delivered to a strictly established place for applying a food ingredient by controlling the movement of both two-coordinate carrier tables 16 and 17.

The use of the two or more two-coordinate carrier tables 16 and 17 in the conveyor system 3 together with the peripheral temporary storage platforms 28 and 29, respectively, allows one to comprehensively overcome the difficulties associated with using one loading table in case of simultaneous receipt of several orders. In this case, the execution of the second order is possible only after the previous first order has been completed on one table, and only then can the table start executing the second order, then the third, and so on. However, if there are two or more two-coordinate carrier tables, and they additionally have external parking spaces (during the working process), then it is possible to simultaneously execute two or three orders, which increases the manufacturability of work and raises the productivity of the culinary system by at least two times.

The use of the above-described option of transferring the food components with the food bases 11 from one two-coordinate table to another also makes it possible to speed up the cooking process, since in this case, after one carrier table has finished executing its order, and, for example, the order is transferred for baking to the furnace installation 10, another carrier table is not idle, but drives up to the neighboring carrier table, on which the second order is executed, picks up this order for itself and arranges its further execution. In this case, the efficiency of using each two-coordinate carrier table increases sharply, since the first table does not stand idle and performs useful work almost all the time, and another two-coordinate carrier table at this time returns to the extreme section of the topping route, is located mainly on the peripheral platform 28 and ready to receive the next order.

Thus, the orders executed according to the recipe and the predetermined cooking parameters enter the packaging subsystem 14 either from the furnace installation 10 or directly from the conveyor system 3. Moreover, the products coming from the furnace installation are transferred to the packaging subsystem 14 through a product transferring element 12 which is made as an automatic piston-pusher with a gripping device that holds and guides the products, and the products entering the packaging subsystem 14 directly from the conveyor system 3 are transferred through the product transferring means 18.

Next, the packaged products come from the packaging subsystem 14 to the finished and packaged storage and issuance subsystem 15.

The storage subsystem 15 has equipment for temporarily storing and distributing resulting orders, which, as necessary, are fed into an issuing window based on a command from the intelligent control device 1 in accordance with the previously placed order.

After the order is completed, the intelligent control device 1 sends a signal to the central serving server 2 which sends a notification to a client on his/her mobile device or in another way, including notifying an operator that the order is ready and is to be transferred to a specific customer.

If the order was placed remotely via the Internet, the received notification comprises a secret code that allows one to identify this customer, for which the customer approaches the storage subsystem 15, enters this code on a touch screen, or brings the mobile device to a system reader and shows a QR code received from the central serving server 2.

The program installed on the intelligent control device 1 identifies this customer and activates the pick-up location where the product has arrived, whereby the customer has a direct opportunity to receive the order he/she has selected.

It should be additionally taken into account that at least one two-coordinate carrier table 16 or 17 may comprise the product quality monitoring tool 6.

During the movement of the two-coordinate carrier tables 16 and 17, the product quality monitoring tool 6 transmits, to the intelligent control device 1, information about the appearance of the food base 11 before and after the application of food ingredients and/or components, and the absence of foreign objects on the food base 11 is also monitored.

If the software of the intelligent control device 1 determines a low quality assessment and deficiencies of the analyzed food base 11, for example, the uneven application of an ingredient, then the intelligent control device 1, having determined this fact, will be able to command the system of the two-coordinate carrier tables 16 and 17 and change the state of the food base 11, i.e., create the necessary operational modes for the equipment of the food distribution system 5 and the conveyor system 3 which are aimed at eliminating the product deficiencies.

If it is technically impossible to correct the food base 11, the intelligent control device 1 transmits control signals to executive elements 13 for removing low-quality products. These executive elements 13 for removing the low-quality products, as a rule, are located within the transferring means at the extreme sections of the conveyor system 3 and are implemented as separate installed modules equipped with a pusher-piston with a stop, which remove the low-quality products, transferring them to disposal subsystems.

In the presented embodiment, the main production equipment of the proposed intelligent culinary system is functionally combined for visual inspection and is covered with a transparent protective showcase.

For security purposes, the proposed intelligent culinary system may be limited on all sides by a housing fence containing a service opening.

The culinary system may be implemented as a stationary vending machine, a system installed on a vehicle or containing wheels for moving, or the proposed system may be installed indoors as a stationary trading facility.

The proposed invention may be widely used in the food service industry, as a safe and technologically advanced fast-food system.

What is claimed is:

1. An intelligent culinary system for the urgent preparation of individual customer orders, comprising:
a food distribution system; and
a conveyor system that is configured to interact with the food distribution system;
wherein the food distribution system is configured as a set of robotic metering modules for topping a given number of incoming pre-prepared food bases with portions of edible ingredients according to a certain work cycle;
wherein the conveyor system comprises at least two robotic functionally synchronized two-coordinate carrier tables mounted on an equipped supporting track facility, at end sections of which there are peripheral platforms for temporarily receiving the two-coordinate carrier tables during a working process;
wherein the two-coordinate carrier tables are configured to perform a movement, including a joint movement, along a pre-determined tailored topping route controlled by an intelligent control device according to pre-received, pre-established parameters of an ordered food dish that is able to be fully or partly moved by product transferring means from an independently movable working platform of one two-coordinate carrier table to an independently movable working platform of another two-coordinate carrier table.

2. The system of claim 1, wherein the supporting track facility is configured as two statically mounted guides.

3. The system of claim 2, wherein the statically mounted guides are structurally adapted to interact with roller mechanisms.

4. The system of claim 1, wherein the independently movable working platform of the two-coordinate carrier tables is installed on a base and has a lower part that moves in a longitudinal direction and an upper part that moves in a transverse direction.

5. The system of claim 1, wherein the two-coordinate carrier tables are equipped with product quality monitoring tools.

6. The system of claim 5, wherein the product quality monitoring tool is configured as a photo or video camera.

7. The system of claim 5, wherein the intelligent control device is configured to analyze incoming images from the product quality monitoring tools and subsequently generate, in case of incomplete reference compliance of products, programmed command signals activating necessary operational modes of equipment which are aimed at eliminating deficiencies of the products.

8. The system of claim 1, wherein the food bases are made from dough, are preferably flat and have a round or oval or rectangular or square configuration.

9. The system of claim 1, wherein the robotic metering modules of the food distribution system are installed sequentially in a row and comprise loose, pasty, solid, semi-solid, and liquid food additives and ingredients.

10. The system of claim 9, wherein the food additives and ingredients comprise meat or sausage products or ham or fish or cheese or vegetables or fruits or berries or herbs or sauce or spices or oil or syrup or cereals or dough.

11. The system of claim 1, wherein the product transferring means are provided on the independently movable working platforms of the two-coordinate carrier tables and are implemented as automatic electric drive systems comprising horizontally moving feeders which are activated if the two-coordinate tables come into contact with each other.

12. The system of claim 4, wherein the independently movable working platform of the two-coordinate carrier tables is additionally configured to rotate around an axis.

13. The system of claim 1, wherein the two-coordinate carrier tables comprise reference scales.

14. The system of claim 1, wherein the peripheral platforms for temporarily receiving the two-coordinate carrier tables are equipped with means for removing low-quality food bases.
